(19) United States
(12) Patent Application Publication
(10) Pub. No.: US 2015/0339716 A1
(43) Pub. Date: Nov. 26, 2015

(54) ONLINE CLASSIFIED WEBSITE FOR SPECIFIC GEOGRAPHIC REGIONS AND METHOD FOR MARKETING THE SAME

(71) Applicant: Barry Lee Guevremont, Seven Springs, NC (US)

(72) Inventor: Barry Lee Guevremont, Seven Springs, NC (US)

(21) Appl. No.: 14/718,062

(22) Filed: May 20, 2015

Related U.S. Application Data
(60) Provisional application No. 62/000,896, filed on May 20, 2014.

(51) Int. Cl. G06Q 30/02; G06Q 30/06; G06Q 50/00

(52) U.S. Cl. CPC G06Q 30/0259; G06Q 30/0246; G06Q 30/0247; G06Q 30/0267; G06Q 30/0277; G06Q 50/01; G06Q 30/0256; G06Q 30/0601

(57) ABSTRACT

A computer implemented method for operating an online classified advertisement which includes creating a plurality of online classified websites, each website corresponding to a specific geographic location and having a corresponding administrator, embedding each online classified website with a code including identification information corresponding to the administrator and a targeted advertising program, selling advertising rights of each website to a website manager, the website manager selling advertising space on each purchased website to a business merchant located in the specific geographic location, measuring online web traffic for each website, calculating first profits generated based on the embedded code and the measured online web traffic for each website, transmitting the first profits to the administrator identified in the identification information, calculating second profits generated based on the measured online web traffic and the sold advertising space for each website, and transmitting the second profits generated to the website manager.

### CROSS-REFERENCE TO RELATED APPLICATIONS

This application claims the benefit of U.S. Provisional Patent Application No. 62/000,896, filed on May 20, 2014, the disclosure of which is incorporated herein in its entirety by reference.

### BACKGROUND OF THE INVENTION

1. Field of the Invention

The present general inventive concept relates to a system and method of providing online classified web pages, and more particularly to a system and computer implemented method of creating and viewing online classified advertising for specific geographic locations using mobile devices.

2. Description of the Related Art

Typical online classified websites provide a single website and database which allow buyers and sellers from many geographic locations to post and search for items. However, most of these typical online classified websites only cover larger cities or regions, leaving many geographic areas or county locations without sufficient coverage.

In addition, these conventional online classified websites require large databases which are expensive and costly to maintain and operate. In addition, the conventional online classified websites are often difficult to navigate and fail to provide adequate advertising for business merchants local to buyers and sellers.

Therefore, what is desired is a dedicated webpage for each specific geographic location which provides incentives for administrators and web page managers to advertise and promote local business merchants.

### BRIEF SUMMARY OF THE INVENTION

The present general inventive concept provides a website consisting of online classified web pages focused on specific geographic locations.

The present general inventive concept also provides separate websites and databases for each specific geographic location.

The present general inventive concept also provides a method for providing and profiting from advertising placed on the individual online classified websites.

The present general inventive concept also provides a method for promoting and profit-sharing from advertising placed on the individual online classified websites.

Additional aspects and utilities of the present general inventive concept will be set forth in part in the description which follows and, in part, will be obvious from the description, or may be learned by practice of the general inventive concept.

Features and/or utilities of the present general inventive concept may be achieved by providing a computer implemented method for operating an online classified advertisement, the method includes creating a plurality of online classified websites, each website corresponding to a specific geographic location and having a corresponding administrator, embedding each online classified website with a code including identification information corresponding to the administrator and a targeted advertising program, selling advertising rights of each website to a website manager, the website manager selling advertising space on each purchased website to a business merchant located in the specific geographic location, measuring online web traffic for each website, calculating first profits generated based on the embedded code and the measured online web traffic for each website, transmitting the first profits to the administrator identified in the identification information, calculating second profits generated based on the measured online web traffic and the sold advertising space for each website and transmitting the second profits generated to the website manager.

The specific geographic location may include state, city, town, suburb, county, borough, village, and district.

The computer implemented method may further include storing the measured online web traffic for each website in a web accessible storage medium and may be executed using a processor on a mobile device.

The computer implemented method may utilize a mobile application configured to allow a buyer user to search for items for sale on an online classified website of the plurality of online classified websites within the specific geographic location and a seller user to post items for sale on an online classified website of the plurality of online classified websites.

The items for sale posted by the seller user may post simultaneously to a website corresponding to the specific geographic location and to an external social network website corresponding to the same specific geographic location.

Features and/or utilities of the present general inventive concept may also achieved by providing a computer implemented method for operating an online classified advertisement which includes an administrator creating a unique classified website for a specific geographic location, embedding the unique classified website with a code including identification information of the administrator and a targeted advertising program, selling advertising rights of the unique classified website to a website manager, the website manager selling advertising space on the purchased unique classified website to local business merchant within the specific geographic location, tracking web traffic information of the purchased unique classified website, storing the web traffic information, calculating first profits generated based on the embedded targeted advertising program and the stored web traffic information for the unique classified website, transmitting all the first profits to the administrator identified in the identification information, calculating second profits generated based on the sold advertising space and the stored web traffic information for the unique classified website, transmitting the second profits to the administrator and the website manager.

The specific geographic location may include state, city, town, suburb, county, borough, village, and district.

The computer implemented method may further include storing the measured online web traffic for each website in a web accessible storage medium and may be executed using a processor on a mobile device.

The second profit may be transmitted to the administrator and the website manager based on a predetermined percentage. In an exemplary embodiment, the percentage may be equal such as 50 percent for each. However, the present general inventive concept is not limited thereto.

### BRIEF DESCRIPTION OF THE DRAWINGS

These and/or other utilities and aspects of the present general inventive concept will become apparent and more readily appreciated from the following description of the embodiments, taken in conjunction with the accompanying drawings of which:

FIG. 1 is a schematic block diagram of an online classified website system according to an exemplary embodiment of the present general inventive concept;

FIG. 2 is a flow diagram illustrating a method of operating the online classified website system illustrated in FIG. 1, according to an exemplary embodiment of the present general inventive concept;

FIG. 3 is a schematic block diagram illustrating a more detailed view of the system illustrated in FIG. 1;

FIG. 4 is a schematic detail overview map of a mobile application implementing the method according to an exemplary embodiment of the present general inventive concept; and

FIGS. 5-14 are details of screenshots of the mobile application illustrated in FIG. 4.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures. However, the present general inventive concept may be embodied in many different forms and should not be construed as limited to the embodiments set forth herein; rather these embodiments are provided so that this disclosure will be thorough and complete, and will convey the scope of the invention to those skilled in the art.

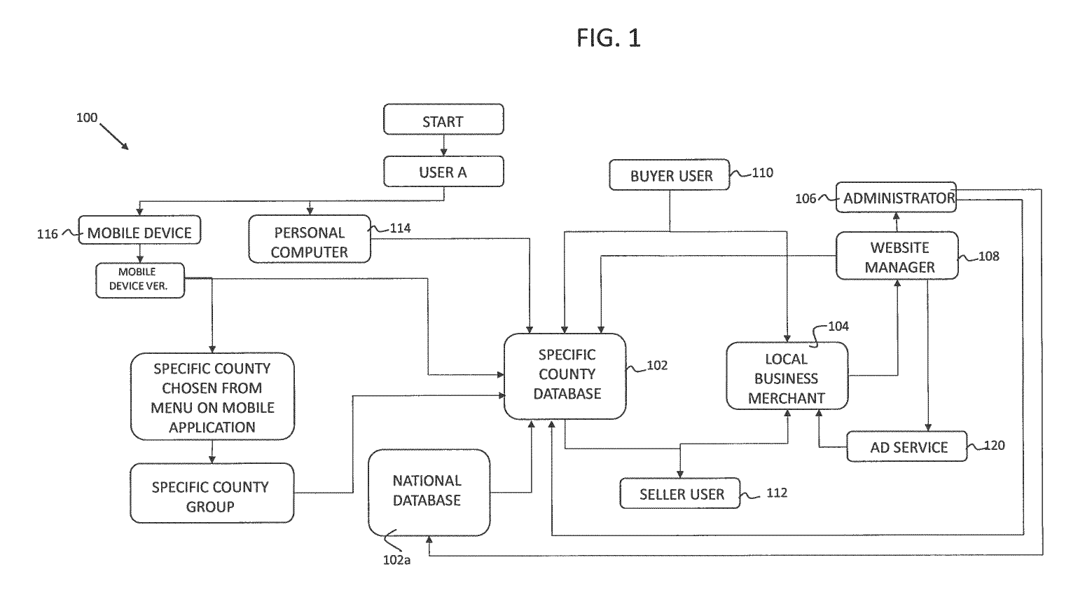

FIG. 1 is a schematic block diagram of an online classified website system 100 according to an exemplary embodiment of the present general inventive concept.

Referring to FIG. 1, the online classified website system 100 includes a plurality of websites corresponding to specific geographic areas. Each website communicates with a dedicated database 102 (i.e., specific county database). The websites include posts for items on sale, advertisements for local businesses, and various other items corresponding to the specific geographic areas. For instance, website would include posts for items on sale in Wayne County, NC and would be stored within the specific county database 102. Similarly, the website would also include advertisements for business merchants local to Orange County, NC and would be stored within the specific county database 102.

In the present exemplary embodiment, the online classified website system 100 provides a website and corresponding database for each specific geographic location. The geographic locations may include a state, a city, a town, a county, a suburb, a neighborhood, or an apartment complex within a defined location. However, the present general inventive concept is not limited thereto.

The online classified website system 100 provides individual online classified websites for each county in the United States. There are over three-thousand counties in the U.S. and each county would have a dedicated online classified advertising website.

In exemplary embodiments, the individual website for each geographic location may be mirrored in different languages, such as Spanish and Chinese, thereby increasing the available advertising space by 100% for each language.

In the present embodiment, an administrator 106 would configure and setup each website for each specific geographic area. The administrator 106 would then sell or lease the rights to use and manage the website to website manager 108. The administrator 106 would then embed a code or script (i.e., AdSense) within the website in order to generate advertising revenue from an amount of clicks or views the website receives. The advertising revenue generated from the website is transmitted to the administrator 106. Similarly, the advertising revenue generated from other websites corresponding to other geographic areas are also transmitted to the administrator 106.

In addition, the website manager 108 may place any additional advertisements on the website purchased or leased from administrator 106 and the website manager 108 may receive all or a percentage of revenues generated from such advertisements. The website manager 108 may then promote and advertise the website within the specific geographic area such that buyers and sellers (i.e., buyer users and seller users) may visit the website and buy and/or sell items within that specific geographic area. For instance, the seller user 112 may reside in a first geographic area and may post an item for sale on the website corresponding to the first geographic area. The buyer user 110 may also reside in the first geographic area and may search for items for sale within the first geographic area or from any other geographic area. The web traffic generated on the website from the buyer user 110 and the seller user 112 is tracked and recorded using various website advertising tools, such as AdSense. The web traffic may include a number of impressions, web page visits, or the like.

In the present general inventive concept, the script or code associated with the advertising tool AdSense has been embedded within the website and has been configured to generate profit for the administrator 106. However, the present general inventive concept is not limited thereto. That is, in alternative exemplary embodiments, various other advertising tools may be used by the administrator 106 to receive a profit from web traffic generated on each website generated from the buyer user 110 and the seller user 112.

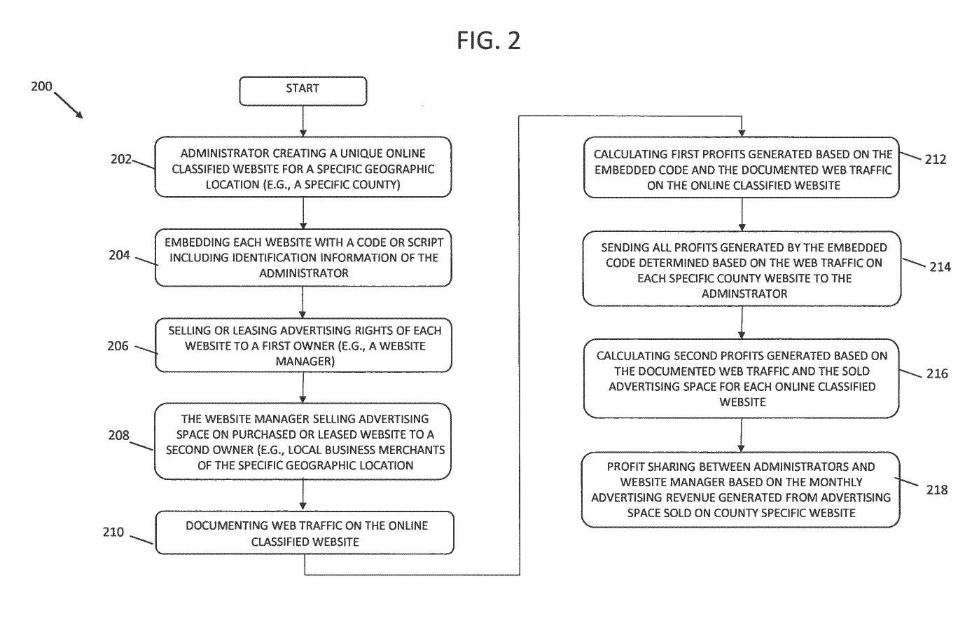

FIG. 2 is a flow diagram illustrating a method 200 of operating an online classified website system 100 illustrated in FIG. 1 according to an exemplary embodiment of the present general inventive concept.

The method 200 of operating an online classified website system 100 includes an administrator 106 (or company) creating a unique online classified website for a specific geographic location, wherein each website includes a dedicated database 102 (i.e., specific county database SCD) (step 202). Each website includes identification information of the corresponding administrator 106. In exemplary embodiments, the specific geographic location may be organized by state, city, town, suburb, county, borough, village, and/or district. However, the present general inventive concept is not limited thereto. In alternative exemplary embodiments, the website may communicate with a national database (NDB) 102a.

At step 204, each website is embedded with a code or script which includes identification information corresponding to the administrator 106 setting up the website.

At step 206, the administrator 106 may sell or lease advertising rights of each website corresponding to the administrator 106 to a website manager 108. However, the administrator 106 retains rights to the revenue generated by any embedded code including targeted advertising programs linked or embedded within the websites.

At step 208, the website manager 108 may then sell or lease rights to advertising space on each website corresponding to the administrator 106 to a local business merchant 104.

At step 210, web traffic for each website is measured and recorded. In exemplary embodiments, the measured online web traffic for each website may be stored in a storage medium.

At step 212, profits (i.e., first profits) earned on the website generated based on the embedded code and the web traffic for each website is calculated.

At step 214, the calculated first profits are then transmitted or sent to the administrator 106 identified in the identification information embedded in the code or transcript on the website.

At step 216, profits (i.e., second profits) earned on the website generated based on advertisements sold by the website manager are then calculated.

At step 218, the calculated second profits are then transmitted or sent to the website manager 108.

In use, a user (i.e., a buyer user 110 and a sever user 112) would first select a method of accessing ND 102a or the SOD 102 either through a personal computer 114 or a mobile device 116. When selecting the personal computer 314, the user would be provided access to the ND 102a or the county database (i.e., county Facebook group).

When selecting the national database 102a, the user could refine a geographic location by selecting a specific county using the specific county database 102. In an alternative embodiment, the user may select the specific county database 102 directly, without selecting or choosing the national database 102a. This allows the users to target their searches for desired counties, instead of searching a much larger national database 102a.

In the present exemplary embodiment, when the user uses the mobile device 116, the user is provided with a first option of selecting a mobile version of the national database or a second option of selecting a county specific database. When selecting the mobile version of the national database, the user is provided with complete access with the specific county database. When selecting the specific county database, the user is provided with an application which allows the user to easily and quickly post items for sale while using a mobile device or a tablet. For instance, the application allows the user to post advertisements to the website by using short form for entering a category, item title, item description, item price, and location and also allow the user to easily capture images of the item using the mobile device or tablet. In the present embodiment, the posted advertisement is simultaneously listed on the specific county database and the county database.

The user may either be a buyer user or seller user of items listed on the website. Both buyer user and seller user may use the websites on the specific county database to browse, shop, and list items for sale. The seller user and the buyer user would both benefit from having local business merchants advertise on the websites organized within the specific county database. As such, the local business merchants would also benefit from having a low cost advertising rates from banner ads and links placed on the SOD 102. In addition, the local business merchants would also benefit in having the SCD 102 target buyer users 310a and seller users 310b who live within the same county or region as the local business merchant which maximizes the return and value of advertising money spent on advertising space on the websites. That is, in the present exemplary embodiment the local business merchants (LBM) would purchase advertising space and website services including website banners ads and links on each website from the website manager 108. The website manager 108 manages the SCD 102 and coordinates with the seller users 112, the buyer users 110, and the local business merchants 104.

An aspect of the present general inventive concept is to encourage users to buy and sell within the county level which provides the most return for local business merchants 104 advertising budget. The website manager 108 sells all types of advertising and business related services including banner ads, links to the local business merchants website, custom advertising designs, graphic design, photography, video production, animation services and website development to local business merchants.

In the present exemplary embodiment, the website manager 108 pays the administrator 106 a monthly fee for access to the SCD 102 and/or the larger national database 102a. In addition, the website manager would pay the administrator 106 a predetermined percentage of the amount of revenue generated by providing advertising services to the local business merchants. As such, the administrator 106 earns revenue from monthly fees sold to each website manager and also the predetermined percentage of the monthly advertising revenue services 120 sold to the local business merchants.

In the present exemplary embodiment, the number of possible website managers equals the number of counties in the United States of America. However, the present general inventive concept is not limited thereto. For instance, each of the 3,124 counties of the United States would have only one website manager. The website manager would have exclusive rights to sell to local business merchants in each county. For example, a website manager would pay a predetermined monthly fee (e.g., 20 USD) for the exclusive right to sell advertising services to local business merchants within a specific county. In addition, the website manager would pay the administrator 106 a predetermined percentage of advertising sales revenue generated by the website manager.

Further, the administrator 106 retains rights to revenue generated by embedded code revenue programs such as Google AdSense™ within each website. However, the present general inventive concept is not limited thereto. That is, the embedded code programs may include various other methods and techniques of generating revenue from code or scripts on or within websites.

Embedded code revenue programs such as Google AdSense™ are targeted advertising based on users search habits on the internet and display advertising targeted to users interests and search history. Web traffic from users merely viewing the website having an embedded code revenue system would be recorded as clicks and the administrator 106 would be compensated a certain amount of money per click. In the present exemplary embodiment, one hundred percent of embedded code revenue is the property of the administrator 106. In addition, the administrator 106 would also earn revenue from direct sales on advertising on the state level so that each of the 50 states has advertising space viewed on the state or national level.

The present general inventive concept provides a website consisting of online classified web pages focused on specific geographic locations, such as counties. The present general inventive concept also provides a method for providing and profiting from advertising placed on the individual online classified websites. The present general inventive concept also provides a method for promoting and profit-sharing from advertising placed on the individual online classified websites.

Administrators, website managers, local business merchants, and users would all benefit from providing the method according to the present general inventive concept wherein the website managers have exclusive rights to specific geographic areas and local business merchants can efficiently advertise to users with their local area. The administrators benefit by receiving revenues generated by code embedded within each website and a percentage of advertising sales generated by the website managers 108 from the local business merchants 104.

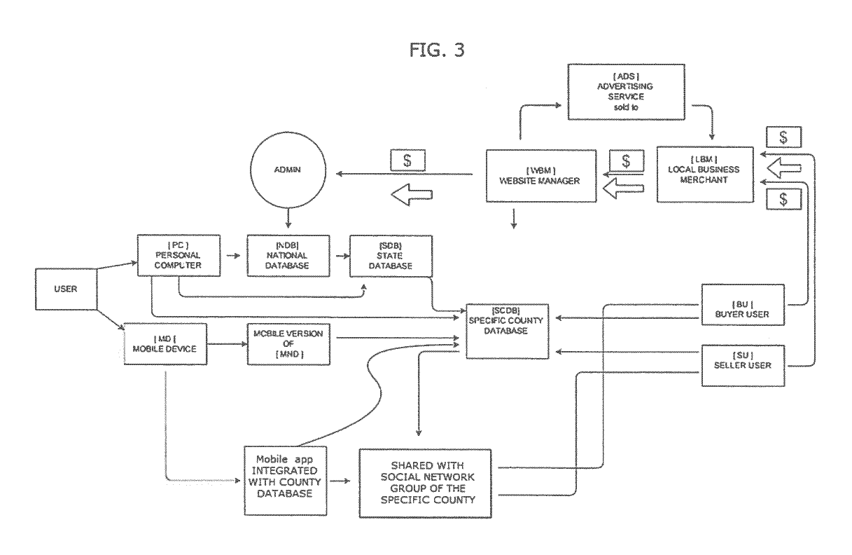

FIG. 3 is a schematic block diagram illustrating an expanded view of FIG. 1 according to an exemplary embodiment of the present general inventive concept. The method 200 of operating an online classified website system according to an exemplary embodiment of the present general inventive concept may be implemented and/or performed on a computer, a mobile device, a smartphone or a tablet. That is, the method 200 may be implemented as a mobile application 300 stored and executed on a mobile device or the like.

Referring to FIG. 3, a user may choose to use the mobile application 300 to interact directly with a specific county database. The user may select a specific county from a menu located within the mobile application which allows the user to sell or shop directly from a mobile device, smartphone or tablet. The user may then quickly post an item for sale in their own specific county location by entering a category of the item, a title of the item, a description of the item, a price of the item, a photo of item in order to sell the item directly from the mobile application. The user may then be prompted to provide contact information for the user and select a button to post the advertisement online.

The advertisement created by the user using the mobile application 300 will then appear within seconds on the specific county website and would also be share simultaneously and directly to a social network group's website (e.g., Facebook™, Myspace™, Twitter™, Vine™, or the like). The advertisement may be posted directly onto the social network's group page consisting of members living within the same specific county the advertisement was posted. This allows for thousands of members of the specific county social network group to immediately see each advertisement submitted by users through the mobile application 300.

The members of the specific county social network groups may then “like” or share the advertisement posted by the user so that the submitted advertisement is seen by more members of the social network group.

When a member or non-member of the specific county social network group clicks on the “liked” or shared advertisement, the mobile application redirects back to the specific county database for more details regarding the advertisement. The redirection generates additional web traffic for the website, which, in turn, generates additional revenue from the embedded code within the website.

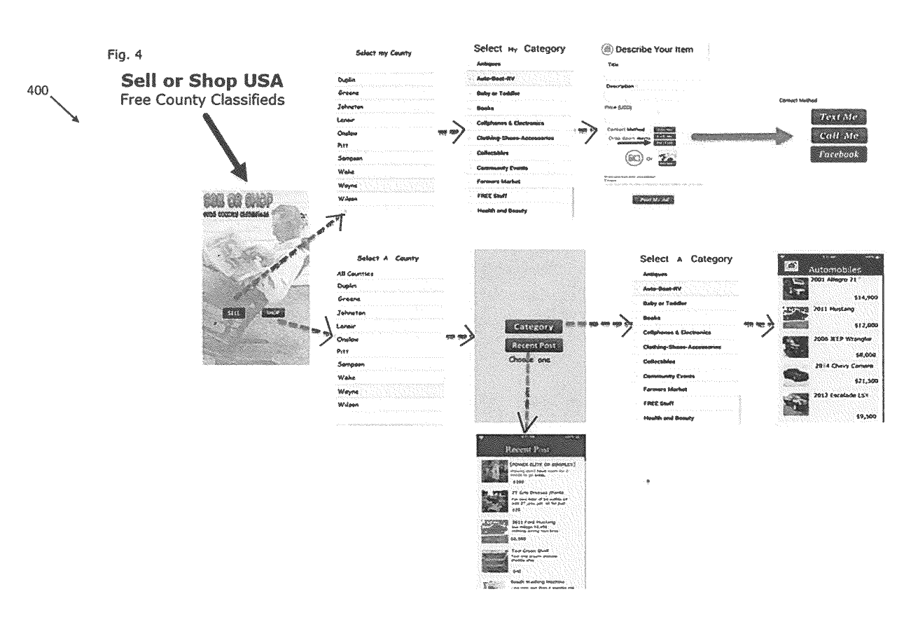

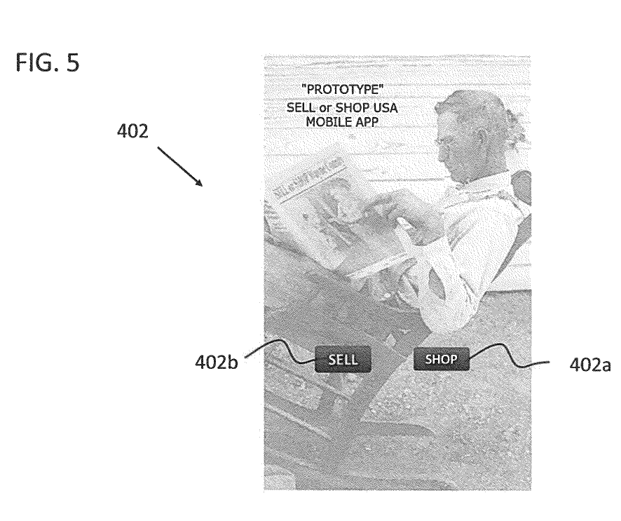

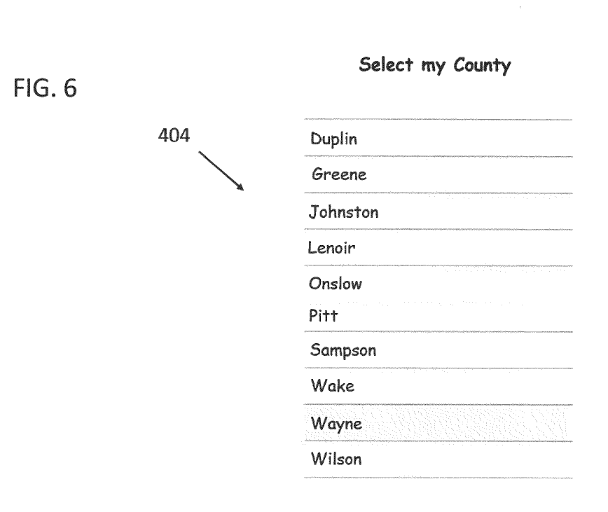

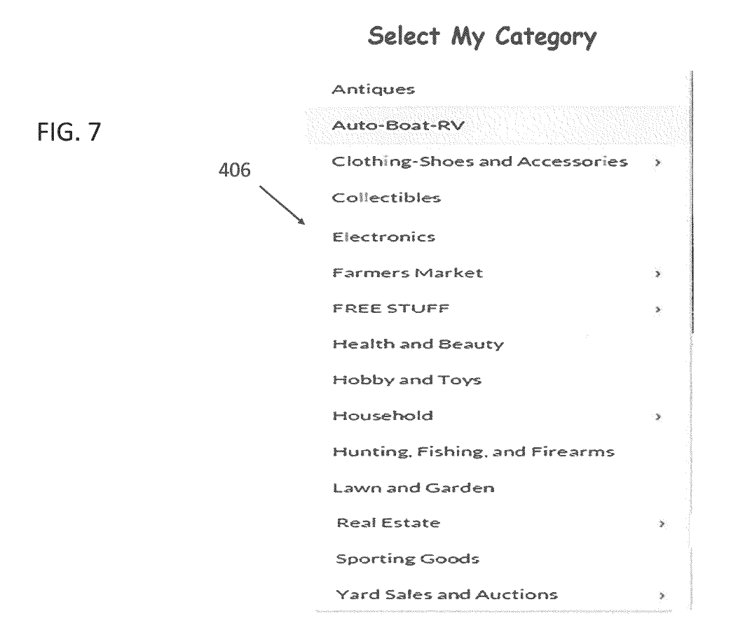

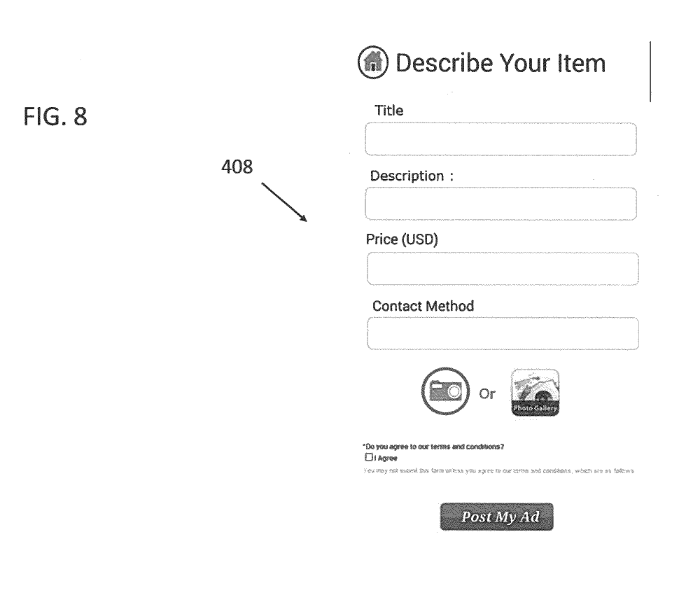

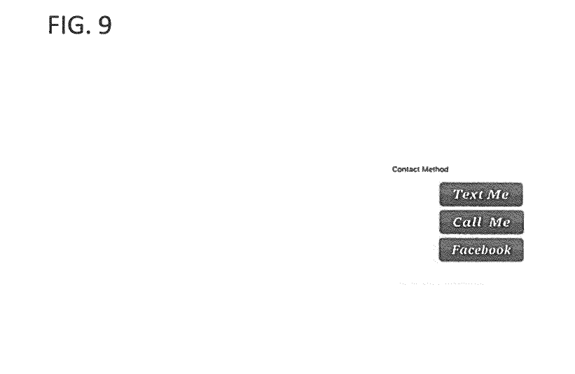

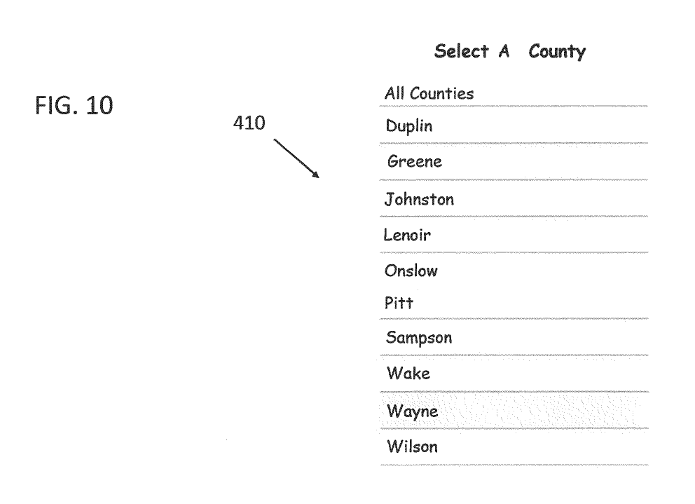

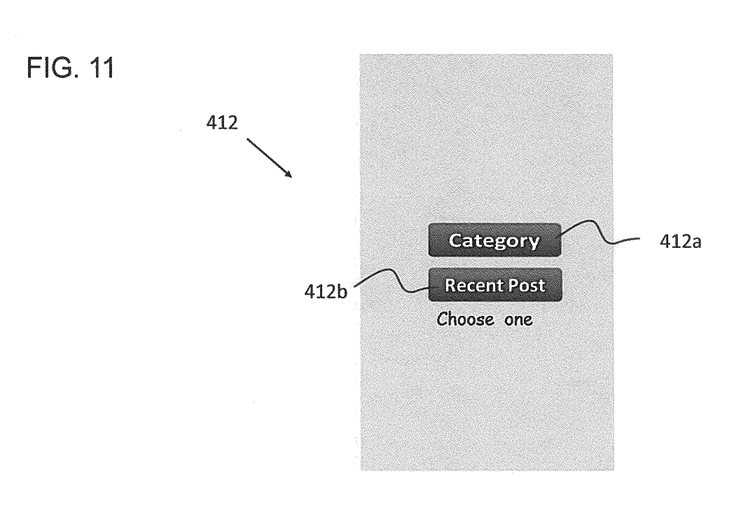

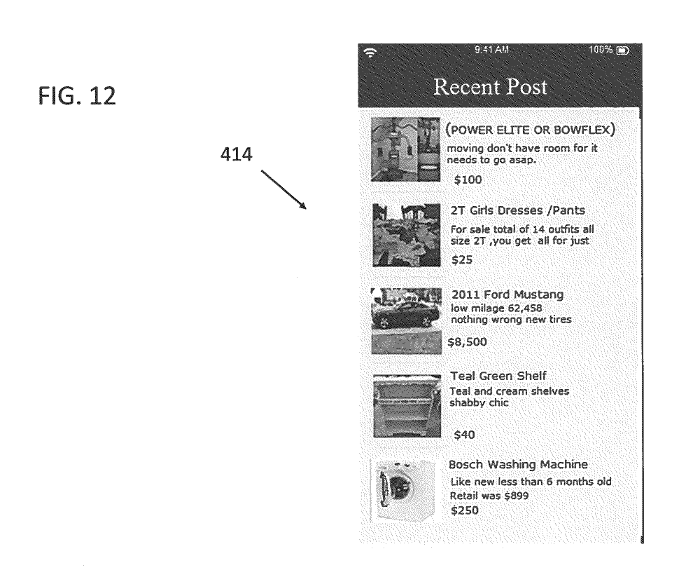

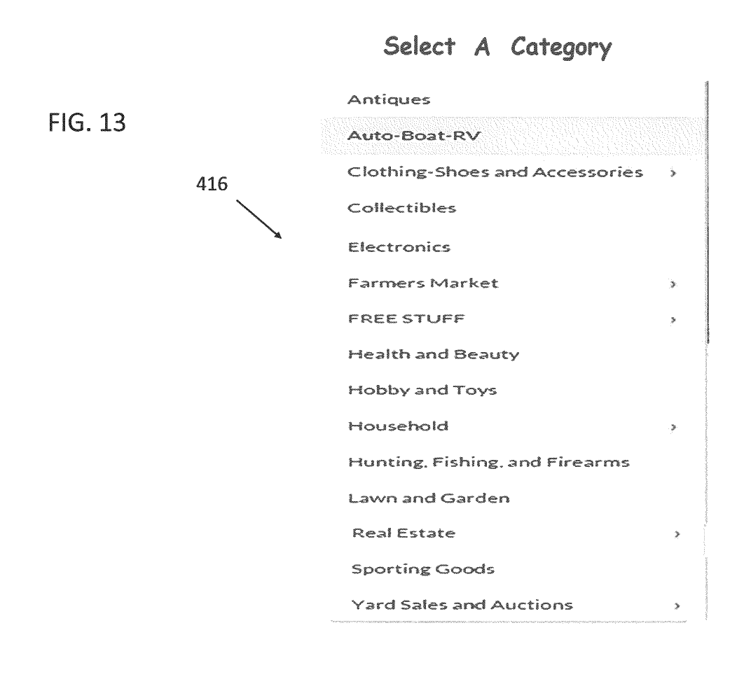

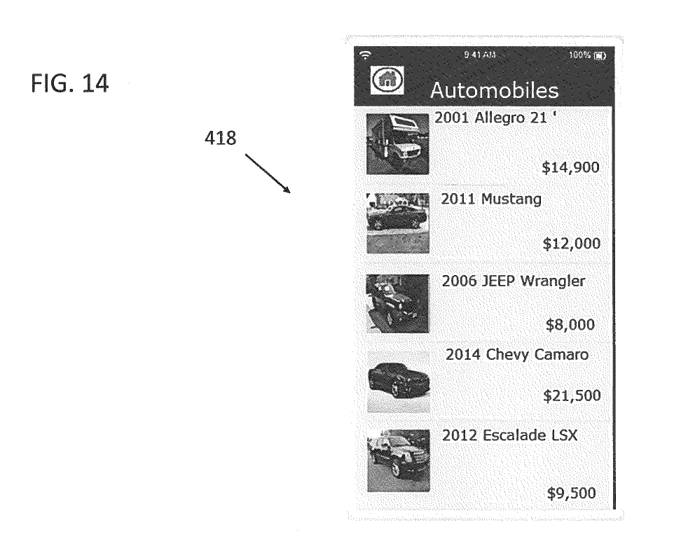

FIG. 4 is a schematic detail overview map of the mobile application implementing a method 400 according to an exemplary embodiment of the present general inventive concept. FIGS. 5-14 are details of screenshots of the mobile application illustrated in FIG. 4.

Referring to FIGS. 4-14, the mobile application implements the method 400 by providing a user with an option to buy 402a or sell 402b from a menu screen 402. When the user selects the sell 402b option, the user is requested to define the user's specific geographic location (e.g., country) from the “my county” selection screen 404. Next, the user is requested to select a category in which to post an item for sale in the “my category” selection screen 406.

The user is then requested to describe the item for sale including a title for the item, a description, a price, and a method of contacting the user in the item description screen 408. The item is then posted to the website and is stored within the specific geographic location database corresponding to the geographic location defined by the user.

When the user selects the shop 402a option, the user is requested to select a specific geographic region in which to search for items in the county selection screen 410. The user may then select a category option 412a or a recent post option 412b from the selection screen 412. By selecting the recent post option 412b, the user is provided with all recent posts for items on sale within the user's defined county on the recent post screen 414. By selecting the category option 412a, the user is provided with a buyer's category selection screen 416. As the user selects a category, a listing of all items within that category (e.g. automobiles) are provided on the items for sale screen 418.

It is to be understood that the foregoing illustrative exemplary embodiments have been provided merely for the purpose of explanation and are in no way to be construed as limiting of the present general inventive concept. Words used herein are words of description and illustration, rather than words of limitation. In addition, the advantages and objectives described herein may not be realized by each and every exemplary embodiment practicing the present general inventive concept. Further, although the present general inventive concept has been described herein with reference to particular structure, steps and/or exemplary embodiments, the present general inventive concept is not intended to be limited to the particulars disclosed herein. Rather, the present general inventive concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the present general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A computer implemented method for operating an online classified advertisement, the method comprising:
creating a plurality of online classified websites, each website corresponding to a specific geographic location and having a corresponding administrator;
embedding each online classified website with a code including identification information corresponding to the administrator and a targeted advertising program;
sexing advertising rights of each website to a website manager;
the website manager selling advertising space on each purchased website to a business merchant located in the specific geographic location;
measuring online web traffic for each website;
calculating first profits generated based on the embedded code and the measured online web traffic for each website;
transmitting the first profits to the administrator identified in the identification information;
calculating second profits generated based on the measured online web traffic and the sold advertising space for each website; and
transmitting the second profits generated to the website manager.

2. The computer implemented method of claim 1, wherein the specific geographic location includes state, city, town, suburb, county, borough, village, and district.

3. The computer implemented method of claim 1, further comprising storing the measured online web traffic for each website in a web accessible storage medium.

4. The computer implemented method of claim 1, further utilizing a mobile application configured to allow a buyer user to search for items for sale on an online classified website of the plurality of online classified websites within the specific geographic location and a seller user to post items for sale on an online classified website of the plurality of online classified websites.

5. The computer implemented method of claim 4, wherein the items for sale posted by the seller user posts simultaneously to a website corresponding to the specific geographic location and to an external social network website corresponding to the same specific geographic location.

6. A computer implemented method for operating an online classified advertisement, the method comprising:
an administrator creating a unique classified website for a specific geographic location;
embedding the unique classified website with a code including identification information of the administrator and a targeted advertising program;
selling advertising rights of the unique classified website to a website manager;
the website manager selling advertising space on the purchased unique classified website to local business merchant within the specific geographic location;
tracking web traffic information of the purchased unique classified website;
storing the web traffic information;
calculating first profits generated based on the embedded targeted advertising program and the stored web traffic information for the unique classified website;
transmitting all the first profits to the administrator identified in the identification information;
calculating second profits generated based on the sold advertising space and the stored web traffic information for the unique classified website;
transmitting the second profits to the administrator and the website manager.

7. The computer implemented method of claim 6, wherein the specific geographic location includes state, city, town, suburb, county, borough, village, and district.

8. The computer implemented method of claim 6, further comprising storing the measured online web traffic for each website in a web accessible storage medium.

9. The computer implemented method of claim 6, wherein the second profits are transmitted to the administrator and the website manager based on a predetermined percentage.
